(19) United States
(12) Patent Application Publication
(10) Pub. No.: US 2019/0162686 A1
(43) Pub. Date: May 30, 2019

(54) HARDNESS MEASUREMENT APPARATUS AND HARDNESS MEASUREMENT METHOD

(71) Applicant: Metal Industries Research & Development Centre, Kaohsiung (TW)

(72) Inventors: Szu-Hua Yang, Kaohsiung City (TW); Chien-Chang Chen, Kaohsiung City (TW); Yii-Der Wu, Kaohsiung City (TW)

(73) Assignee: Metal Industries Research & Development Centre, Kaohsiung (TW)

(21) Appl. No.: 15/823,598

(22) Filed: Nov. 28, 2017

(51) Int. Cl. G01N 27/02

(52) U.S. Cl. CPC G01N 27/025

(57) ABSTRACT

A hardness measurement apparatus including a storage device, a processing device, and an electromagnetic sensing device is provided. The storage device stores a hardness classification model. The processing device generates a control signal. The processing device outputs the control signal to the electromagnetic sensing device to operate the electromagnetic sensing device to sense a metal object in a non-contact sensing manner at a specific frequency. The electromagnetic sensing device outputs an electromagnetic sensing result of the metal object to the processing device. The processing device analyzes the electromagnetic sensing result to determine the impedance parameter of a sensing coil. The processing device determines a hardness of the metal object according to the impedance parameter the sensing coil and the hardness classification model. In addition, a hardness measurement method is also provided.

### TECHNICAL FIELD

The disclosure is related to a classification technology, and particularly to a hardness measurement apparatus and a hardness measurement method.

### BACKGROUND

In the manufacturing process of metal elements, if a plurality of metal elements having the same shape and appearance are respectively processed via different thermal treatment process, these metal elements having the same shape and appearance are likely to have different hardness. In this regard, manufacturers need to measure the metal elements one by one for classification. However, conventional hardness measurement method of metal elements is conducted to measure hardness in a destructive manner, and single variable data conversion can only be performed via a single database, which causes that the measurement accuracy is low and the measurement speed is slow. Therefore, conventional hardness measurement method of metal element cannot be effectively applied in classification of metal element. In view of the above, the disclosure provides solutions described in the following embodiments.

### SUMMARY

The disclosure provides a hardness measurement apparatus and a hardness measurement method, which are capable of rapidly and effectively sensing metal object to obtain impedance parameter of sensing coil of which the magnetic field is changed in corresponding to metal object, and determining the hardness of metal object according to the impedance parameter of the sensing coil.

In the disclosure, the hardness measurement apparatus includes a storage device, a processing device and an electromagnetic sensing device. The storage device stores a hardness classification model. The processing device is coupled to the storage device. The processing device generates a control signal. The electromagnetic sensing device is coupled to the processing device. The processing device outputs the control signal to the electromagnetic sensing device to operate the electromagnetic sensing device to sense a metal object in a non-contact sensing manner at a specific frequency. The electromagnetic sensing device outputs an electromagnetic sensing result of the metal object to the processing device. The processing device analyzes the electromagnetic sensing result to determine the impedance parameter of a sensing coil. The processing device determines a hardness of the metal object according to the impedance parameter of the sensing coil and the hardness classification model.

In the disclosure, the hardness measurement method is adapted to a hardness measurement apparatus. The hardness measurement apparatus includes an electromagnetic sensing device. The hardness measurement method includes the following steps: establishing a hardness classification model; operating the electromagnetic sensing device to sense a metal object in a non-contact sensing manner at a specific frequency, and generating an electromagnetic sensing result of the metal object using the electromagnetic sensing device; analyzing the electromagnetic sensing result to determine impedance parameter of a sensing coil; and determining the hardness of the metal object according to impedance parameter of the sensing coil and the hardness classification model.

In summary, the hardness measurement apparatus and hardness measurement method of the disclosure can sense the metal object in the non-contact sensing manner to effectively and rapidly acquire the impedance parameter of the sensing coil, and accurately determine the hardness of metal object according to the hardness classification model that is established in advance and impedance parameter of the sensing coil.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a hardness measurement apparatus according an embodiment of the disclosure.

FIG. 2 is a schematic view of an electromagnetic sensing device according to an embodiment of the disclosure.

FIG. 3 is a schematic view of an annular coil and a metal object according to an embodiment of the disclosure.

FIG. 4 is a flowchart of a hardness measurement method according to an embodiment of the disclosure.

FIG. 5 is a schematic view of a hardness classification model according to an embodiment of the disclosure.

FIG. 6 is a flowchart of a hardness measurement method according to another embodiment of the disclosure.

### DESCRIPTION OF EMBODIMENTS

In order to make the disclosure more comprehensible, embodiments are described below as the examples to prove that the disclosure can actually be realized. In addition, wherever possible, elements/components/steps denoted by the same reference numerals in drawings and embodiments represent the same or similar parts.

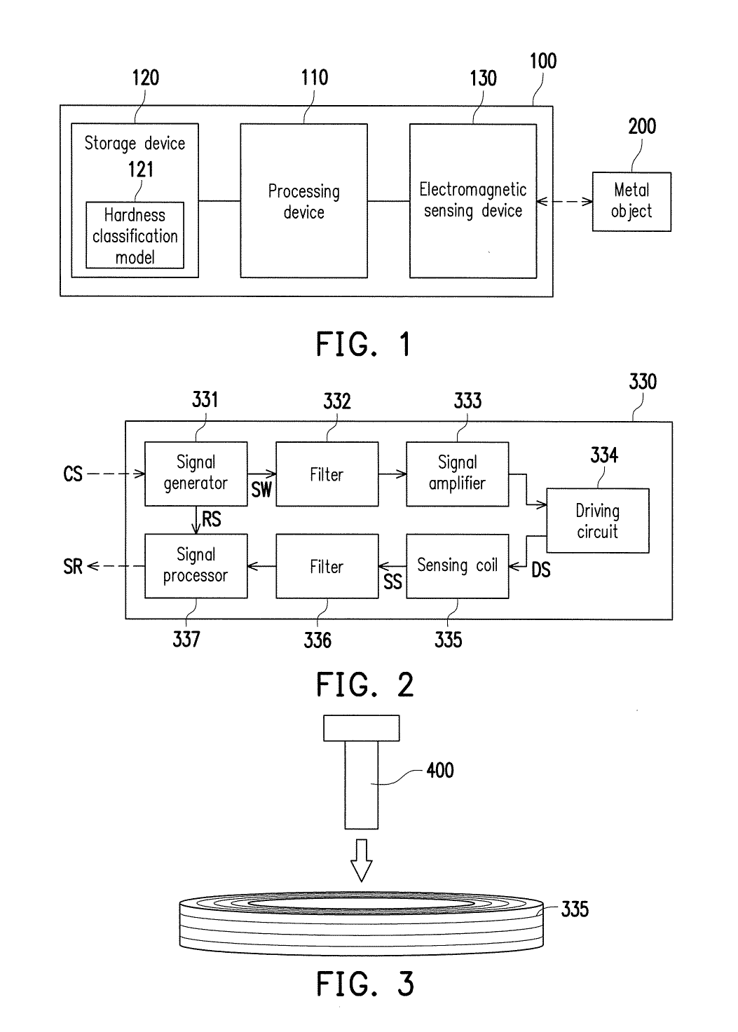

FIG. 1 is a schematic view of a hardness measurement apparatus according an embodiment of the disclosure. Referring to FIG. 1, a hardness measurement apparatus 100 includes a processing device 110, a storage device 120 and an electromagnetic sensing device 130, wherein the electromagnetic sensing device 130 includes a sensing coil. In the embodiment, the storage device 120 and the electromagnetic sensing device 130 are coupled to the processing device 110. The storage device 120 stores a hardness classification model 121. In the embodiment, the hardness measurement apparatus 100 senses a metal object 200 in a non-contact sensing manner using the electromagnetic sensing device 130 to acquire an electromagnetic sensing result of the metal object 200. The processing device 110 analyzes the electromagnetic sensing result of the metal object 200 to determine impedance parameter of the sensing coil of the electromagnetic sensing device 130, and determine the hardness of the metal object 200 according to the impedance parameter of sensing coil and the hardness classification model 121.

However, it should be noted that the hardness described in each of embodiments of the disclosure refers to a surface hardness of the metal object 200, and the electromagnetic sensing device 130 senses the metal object 200 via an eddy current sensing technology. In other words, since the surface hardness of the metal object 200 is associated with magnetic field change of the sensing coil of the electromagnetic sensing device 130 in the sensing process, the hardness measurement apparatus 100 of the embodiment acquires corresponding impedance parameter change by calculating difference in the magnetic field change of the sensing coil, such that the hardness measurement apparatus 100 determines the hardness of the metal object 200 by judging the change of impedance parameter of the sensing coil before/after the sensing process. In the meantime, in an embodiment, the hardness measurement apparatus 100 further cooperates with a material property database to establish association between impedance parameter and hardness.

In addition, the calculating method of the impedance parameter of the sensing coil in the embodiment is, for example, an impedance deduction formula of the eddy current sensing technology using the following equation (1); however, the disclosure is not limited thereto.

$$Z ( j ω ) = j ωπ {n}_{c}^{2} {μ}_{0} {\int }_{0}^{∞} {U ( {r}_{1} , {r}_{2} , λ )}^{2} [ 2 ( λ d + {e}^{λ d} - 1 ) + α {{e}^{- 2 λ d} ( 1 - {e}^{- λ d} )}^{2} ] d λ \qquad Equation ( 1 )$$

In the above-mentioned equation (1), Z is an impedance of the sensing coil, d is a width of the coil, α is a coefficient, μ0 is a magnetic permeability of air and λ is a current length of the sensing signal, r1 is a coil inner diameter, r2 is a coil outer diameter, n_{c} is a coil turn. In the embodiment, sufficient teaching, suggestions and implementation regarding the impedance parameter calculating method can be inferred by persons skilled in the art according to general electromagnetic principle and derived from ordinary knowledge regarding hardness conversion; thus, no further descriptions are incorporated herein.

In the embodiment, the hardness measurement apparatus 100 establishes the hardness classification model 121 in advance. The hardness classification model 121 includes a plurality of hardness classifications, and the hardness classifications respectively correspond to different impedance parameters. Therefore, when the electromagnetic sensing device 130 measures the impedance parameters, the processing device 110 classifies the metal object 200 into one of the plurality of hardness classifications according to the impedance parameter. In other words, when the hardness measurement apparatus 100 senses a plurality of sensing products having different hardness, the hardness measurement apparatus 100 can rapidly sense the metal products having different hardness one by one in a non-contact sensing method.

In the embodiment, the processing device 110 is, for example, a central processing unit (CPU), a system on chip (SOC) or other programmable general purpose or specific purpose microprocessor, a digital signal processor (DSP), a programmable controller, an application specific integrated circuit (ASIC), a programmable logic device (PLD), other similar processing device or a combination thereof.

In the embodiment, the storage device 120 is, for example, a dynamic random access memory (DRAM), a flash memory or a non-volatile random access memory (NVRAM) and so on. In the embodiment, the storage device 120 stores the data and module described in each of the embodiments of the disclosure to be provided to the processing device 110 to read and execute, so that the hardness measurement apparatus 100 can realize the operation and method described in each of the embodiments of the disclosure.

FIG. 2 is a schematic view of an electromagnetic sensing device according to an embodiment of the disclosure. Referring to FIG. 2, an electromagnetic sensing device 330 includes a signal generator 331, a filter 332, a signal amplifier 333, a driving circuit 334, a sensing coil 335, a filter 336 and a signal processor 337. The signal generator 331 is coupled to the filter 332 and the signal processor 337. The filter 332 is coupled to the signal amplifier 333. The signal amplifier 333 is coupled to the driving circuit 334. The driving circuit 334 is coupled to the sensing coil 335. The sensing coil 335 is coupled to the filter 336. The filter 336 is coupled to the signal processor 337. In the embodiment, the electromagnetic sensing device 330 receives a control signal CS output by the processing device described in the embodiment of FIG. 1 using the signal generator 331, and outputs an electromagnetic sensing result SR to the processing device, for example, described in the embodiment of FIG. 1 using the signal processor 337.

In the embodiment, the signal generator 331 generates a wave signal SW to the filter 332, the signal amplifier 333 and the driving signal 334 according to the control signal CS, and generates a reference signal RS to the signal processor 337. In the embodiment, the wave signal SW is the same as the reference signal RS. In the embodiment, the filter 332 filters the noise in the wave signal SW, and the signal amplifier 333 increases amplitude of the wave signal SW. Therefore, the driving circuit 334 generates a driving signal DS according to adjusted wave signal SW. The driving circuit 334 drives the sensing coil 335 via the driving signal DS to sense the metal object. In the embodiment, the sensing coil 335 senses the metal object and generates a sensing signal SS. The sensing coil 335 outputs the sensing signal SS to the filter 336. The filter 336 filters the noise in the sensing signal SS, and provides the adjusted sensing signal SS to the signal processor 337. Therefore, the signal processor 337 analyzes the sensing signal SS to output the electromagnetic sensing result SR.

FIG. 3 is a schematic view of an annular coil and a metal object according to an embodiment of the disclosure. Referring to FIG. 2 and FIG. 3, the sensing coil 335 described in each of the embodiments of the disclosure may be, for example, as described in FIG. 3. For instance, a metal object 400 is, for example, a metal screw and has a signal metal material or a combination of a plurality of metal materials, which should not be construed as a limitation to the disclosure. In the embodiment, the sensing coil 335 is an annular coil formed of metal material in a single turn or a plurality of turns, and the sensing coil 335 generates an alternating magnetic field. When the metal object 400 passes through an area encircled by the sensing coil 335, the surface of the metal object 400 generates an eddy current, and the sensing coil 335 generates magnetic field change in corresponding to the eddy current on the surface of the metal object 400 to output the sensing signal SS to the signal processor 337.

It should be pointed out that the impedance change of the sensing coil 335 corresponds to the electromagnetic property of material of the metal product, and the electromagnetic property of material of the metal product corresponds to the hardness of metal products. In other words, when the manufacturer manufactures a plurality of metal products (e.g., a plurality of metal screws) with different hardness, the manufacturer can pass the metal products with different hardness through the sensing coil 335 one by one to acquire the result of magnetic field change of the sensing coil 335 corresponding to the metal products with different hardness, and acquire the impedance change of the sensing coil 335 according to the result of the magnetic field change of the sensing coil 335. Therefore, the manufacturer can determine the hardness of the metal products with different hardness according to the impedance change of the sensing coil 335, and classifying the metal products with different hardness according to the degree of hardness.

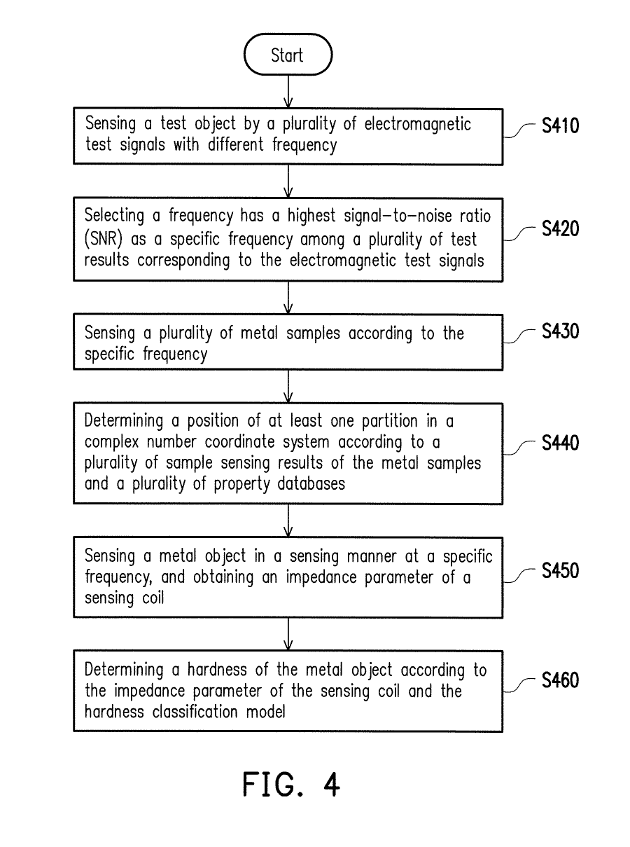

FIG. 4 is a flowchart of a hardness measurement method according to an embodiment of the disclosure. Referring to FIG. 1 and FIG. 4, the hardness measurement method in the embodiment may be at least adapted to the hardness measurement apparatus 100 in FIG. 1. The hardness measurement apparatus 100 may perform step S410 to S460 in sequence to determine the hardness of the metal object 200. First of all, the hardness measurement apparatus 100 in the embodiment determines the specific frequency for sensing the metal object 200 in advance. Therefore, in step S410, the processing device 110 controls the electromagnetic device 130 to sense a test object by a plurality of electromagnetic test signals with different frequencies. Meanwhile, in step S420, the processing device 110 selects one of the frequencies having the highest signal-to-noise ratio (SNR) among the plurality of test results corresponding to the electromagnetic test signals to be used as the specific frequency. In other words, the hardness measurement apparatus 100 in the embodiment has a function of automatically selecting the frequency having higher SNR as the specific frequency according to the electromagnetic property corresponding to the metal material of the metal object 200, so that the hardness measurement apparatus 100 generates the sensing signal according to the specific frequency. In the embodiment, the specific frequency may be, for example, selected within a range from 1 Hz to 900 MHz.

Next, in step S430, the electromagnetic sensing device 130 senses a plurality of metal samples in advance according to the specific frequency, wherein the metal samples may respectively have different hardness. In step S440, the processing device 110 determines the position of at least one partition in a complex number coordinate system according to a plurality of sample sensing results of the metal samples and a plurality of property databases. In other words, the hardness measurement apparatus 100 in the embodiment establishes hardness partitions corresponding to various hardness in advance.

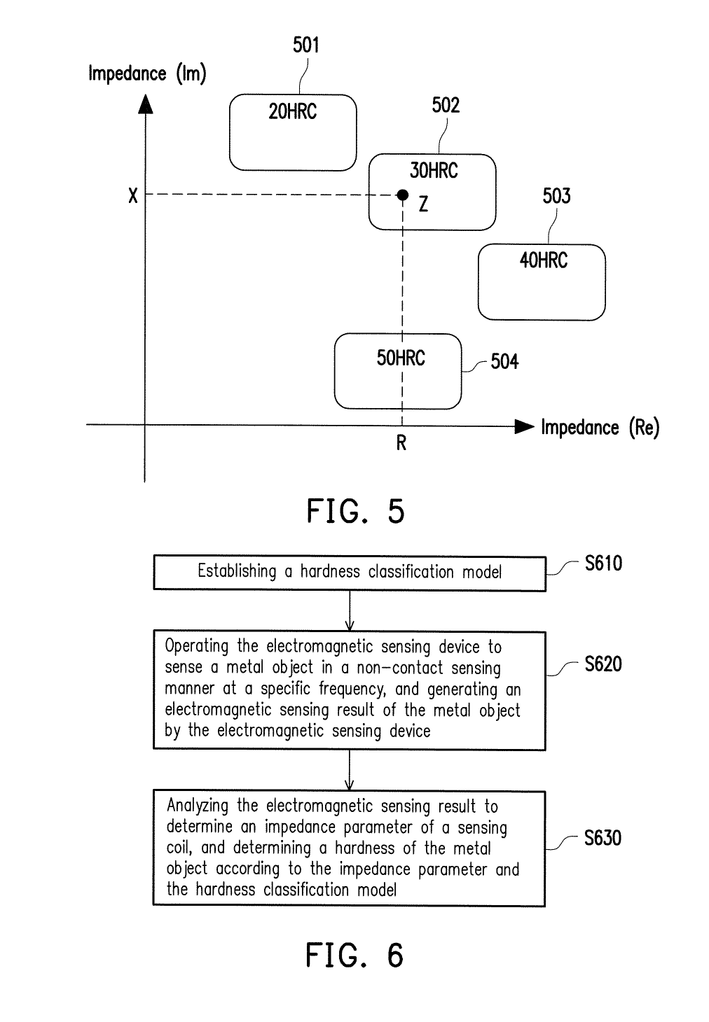

Specifically, FIG. 5 is a schematic view of a hardness classification model according to an embodiment of the disclosure. With reference to FIG. 5, in the embodiment, the hardness classification model stored in the storage device 120 may include a complex number coordinate system information shown in FIG. 5, wherein the horizontal axis represents a real (Re) impedance and the vertical axis represents an imaginary (Im) impedance. In the embodiment, the calculation logic of the hardness measurement apparatus 100 is that the Re impedance is measured first, then the Im impedance is measured, and calculation conversion is performed. Moreover, in the embodiment, the storage device 120 may further store a plurality of property databases, and the processing device 110 senses the plurality of metal samples in advance using the electromagnetic sensing device 130 to determine positions of partitions 501-504 in the complex number coordinate system according to the plurality of sample sensing results of the metal samples and the property databases.

For example, in the embodiment, the partitions 501-504 respectively correspond to different hardness. As shown in FIG. 5, the partitions 501-504, for example, respectively correspond to 20 HRC, 30 HRC, 40 HRC and 50 HRC, which should not be construed as a limitation to the disclosure. When the electromagnetic sensing device 130 senses the metal object 200 to acquire the electromagnetic sensing result of the metal object 200, the processing device 110 analyzes the electromagnetic sensing result to determine an impedance parameter Z of the sensing coil of the electromagnetic sensing device 130. In the example, the impedance parameter Z of the sensing coil of the electromagnetic sensing device 130 is plural, and the form of the complex number coordinate system is represented by R+jX, wherein a real portion of impedance is R, and an imaginary portion of impedance is X. The processing device 110 classifies that the metal object 200 belongs to hardness in partition 502 according to the position of the impedance parameter Z of the sensing coil of the electromagnetic sensing device 130 in the complex number coordinate (R,X) of the complex number coordinate system, wherein the hardness in partition 502 is 30 HRC.

In the embodiment, the property databases, for example, include at least one of a material property database, an electromagnetic property database, a standard metal database, a mechanical property database, a thermal treatment property database and an accessory database. The property databases, for example, provide data of various metal objects 200 such as the material property parameter, the electromagnetic property parameter or thermal property parameter and so on, so that the processing device 110 establishes the hardness classification model according to the property databases and the plurality of sample sensing results. In addition, the relationship between the impedance parameter and the hardness of the embodiment, for example, applies the following deduction equation (2) for impedance parameter and hardness to determine the corresponding position (partition) of the impedance parameter in the complex number coordinate system, which should not be construed as a limitation to the disclosure.

Hardness(HRC)=A×B×Z Equation (2)

In the above-mentioned equation (2), Z is impedance of sensing coil, A is a material magnetic permeability parameter formula set and B is a material conductivity parameter formula set. In the embodiment, sufficient teaching, suggestion and implementation regarding the conversion method of the impedance parameter and hardness can be inferred by persons skilled in the art according to general electromagnetic principle and derived from ordinary knowledge concerning hardness conversion, and thus no further descriptions are incorporated herein.

Thereafter, in step S450, the electromagnetic sensing device 130 senses the metal object 200 in the non-contact sensing manner at a specific frequency, and acquires the impedance parameter of the sensing coil of the electromagnetic sensing device 130. In step S460, the processing device 110 determines the hardness of metal object according to the impedance parameter of the sensing coil of the electromagnetic sensing device 130 and the hardness classification model. Therefore, the hardness measurement method of the embodiment may effectively and rapidly determine the hardness of the metal object.

It should be pointed out that, the partitions 501-504 shown in FIG. 5 respectively represent the hardness respectively corresponding to different impedance ranges. In the embodiment, the hardness measurement apparatus 100 corresponds a specific impedance range to a specific hardness parameter. Since the electromagnetic sensing result of the metal object 200 obtained by the electromagnetic sensing device 130 may be erroneous, or that the metal object 200 is synthesized via a plurality of materials, the disclosure corresponds a specific impedance range to a specific hardness parameter. In other words, the hardness measurement apparatus 100 estimates or infers an impedance range corresponding to one or more specific hardness parameters according to a plurality of sample sensing parameters and a plurality of property databases to establish the hardness classification model 121. In another example, when the manufacturer is to classify a plurality of metal objects with different hardness, the manufacturer can sense the metal objects with different hardness by using the electromagnetic sensing device 130. Moreover, the hardness measurement apparatus 100 only needs to calculate the electromagnetic change generated by the sensing coil of the electromagnetic sensing device 130 in corresponding to the eddy current on the surface of metal object 200 to acquire the impedance parameter of the sensing coil. The hardness measurement apparatus 100 judges the hardness of the metal object 200 according to the position of the impedance parameter of the sensing coil in the complex number coordinate system. In other words, there is no need for the hardness measurement apparatus 100 to spend time performing conversion calculation between the impedance parameter of the sensing coil and the hardness of the metal object 200. Accordingly, the hardness measurement apparatus 100 can effectively and rapidly determine the hardness of the metal objects with different hardness, and effectively and rapidly classify the metal objects with different hardness. In addition, in an embodiment, the hardness measurement apparatus 100 further includes a display device. The display device is coupled to the processing device 110 and displays image frame of classification result. The classification result includes the hardness classification model and hardness information of metal object.

FIG. 6 is a flowchart of a hardness measurement method according to another embodiment of the disclosure. Referring to FIG. 1 and FIG. 6, the hardness measurement method in the embodiment may be at least adapted to the hardness measurement apparatus 100 in FIG. 1. In step S610, the hardness measurement apparatus 100 establishes the hardness classification model 121 in advance. In step S620, the hardness measurement apparatus 100 operates the electromagnetic sensing device 130 to sense the metal object 200 in the non-contact sensing manner at a specific frequency, and generates the electromagnetic sensing result of the metal object 200. In step S630, the hardness measurement apparatus 100 analyzes the electromagnetic sensing result to determine the impedance parameter of the sensing coil of the electromagnetic sensing device 130, and determines the hardness of the metal object 200 according to the impedance parameter of the sensing coil of the electromagnetic sensing device 130 and the hardness classification model 121. Therefore, the hardness measurement method of the embodiment can effectively measure the impedance parameter of the sensing coil and rapidly determine the hardness of the metal object 200 according to the impedance parameter of the sensing coil and the hardness classification model 121.

In addition, sufficient teaching, suggestions and implementation regarding other device feature and implementation details of the hardness measurement apparatus 100 described in the embodiment may be derived from the embodiments of FIG. 1 to FIG. 5; thus, no further descriptions are incorporated herein.

In summary, according to the disclosure, the hardness measurement apparatus and hardness measurement method can efficiently and rapidly sense the metal object in a non-contact manner, and acquire the impedance parameter of the sensing coil according to the result of magnetic field change in the process that the sensing coil senses the metal object, so that the hardness measurement apparatus of the disclosure can correspondingly estimate the hardness of the metal object according to the impedance parameter of the sensing coil and the hardness classification model that is established in advance, such that there is no need to take time to convert the impedance parameter of the sensing coil into the corresponding hardness of the metal object. Therefore, the hardness measurement apparatus and the hardness measurement method of the disclosure are capable of effectively and rapidly measuring hardness of metal object and performing classification of the metal object.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A hardness measurement apparatus, comprising:
a storage device, storing a hardness classification model;
a processing device, coupled to the storage device, and configured to generate a control signal; and
an electromagnetic sensing device, coupled to the processing device, wherein the processing device outputs the control signal to the electromagnetic sensing device to operate the electromagnetic sensing device to sense a metal object in a non-contact sensing manner at a specific frequency, and the electromagnetic sensing device outputs an electromagnetic sensing result of the metal object to the processing device,
wherein the processing device analyzes the electromagnetic sensing result to determine an impedance parameter of a sensing coil, and the processing device determines a hardness of the metal object according to the impedance parameter of the sensing coil and the hardness classification model.

2. The hardness measurement apparatus according to claim 1, wherein the electromagnetic sensing device senses a test object in advance by a plurality of electromagnetic test signals with different frequencies, and the processing device selects one of the frequencies having the highest signal-to-noise ratio among a plurality of test results corresponding to the electromagnetic test signals as the specific frequency.

3. The hardness measurement apparatus according to claim 1, wherein the hardness classification model comprises a complex number coordinate system, and the impedance parameter comprises a real impedance and an imaginary impedance.

4. The hardness measurement apparatus according to claim 3, wherein the complex number coordinate system comprises at least a partition, and the at least one partition respectively corresponds to different hardness.

5. The hardness measurement apparatus according to claim 4, wherein the storage device further stores a plurality of property databases, and the processing device senses a plurality of metal samples in advance by the electromagnetic sensing device, and determines a position of the at least one partition in the complex number coordinate system according to a plurality of sample sensing results of the metal samples and the property databases.

6. The hardness measurement apparatus according to claim 5, wherein the property databases comprise at least one of a material property database, an electromagnetic property database, a standard metal database, a mechanical property database, a thermal treatment property database and an accessory database.

7. The hardness measurement apparatus according to claim 1, further comprising:
a display device, coupled to the processing device, and configured to display a classification result, and the classification result comprises the hardness classification model and the hardness of the metal object.

8. The hardness measurement apparatus according to claim 1, wherein the electromagnetic sensing device comprises:
a signal generator, coupled to the processing device, and configured to receive the control signal, and the signal processor generates a driving signal and a reference signal according to the control signal;
a driving circuit, coupled to the signal generator and the sensing coil, and configured to receive the driving signal, and drive the sensing coil to sense the metal object according to the driving signal, so that the sensing coil outputs a sensing signal; and
a signal processor, coupled to the signal generator and the sensing coil, and configured to receive the reference signal and the sensing signal, and the signal processor compares the reference signal and the sensing signal to output the electromagnetic sensing result to the processing device.

9. The hardness measurement apparatus according to claim 8, wherein the sensing coil generates an alternating magnetic field, so that the metal object correspondingly generates an eddy current, and the sensing coil senses the eddy current to output the sensing signal.

10. The hardness measurement apparatus according to claim 8, wherein the sensing coil is an annular coil, and when the metal object passes through an area encircled by the sensing coil, the sensing coil generates the sensing signal.

11. A hardness measurement method, adapted to a hardness measurement apparatus, and the hardness measurement apparatus comprises an electromagnetic sensing device, wherein the hardness measurement method comprises:
establishing a hardness classification model;
operating the electromagnetic sensing device to sense a metal object in a non-contact sensing manner at a specific frequency, and generating an electromagnetic sensing result of the metal object; and
analyzing the electromagnetic sensing result to determine an impedance parameter of a sensing coil, and determining a hardness of the metal object according to the impedance parameter of the sensing coil and the hardness classification model.

12. The hardness measurement method according to claim 11, further comprising:
sensing a test object in advance by a plurality of electromagnetic test signals with different frequencies by the electromagnetic sensing device, and selecting one of the frequencies having the highest signal-to-noise ratio among a plurality of test results corresponding to the electromagnetic test signals as the specific frequency.

13. The hardness measurement method according to claim 11, wherein the hardness classification model comprises a complex number coordinate system, and the impedance parameter comprises a real impedance and an imaginary impedance.

14. The hardness measurement method according to claim 13, wherein the complex number coordinate system comprises at least a partition, and the at least one partition respectively corresponds to different hardness.

15. The hardness measurement method according to claim 14, wherein the step of establishing the hardness classification model comprises:
sensing a plurality of metal samples in advance by the electromagnetic sensing device to determine a position of the at least one partition in the complex number coordinate system according to a plurality of sample sensing results of the metal samples and a plurality of property databases.

16. The hardness measurement method according to claim 15, wherein the property databases comprise at least one of a material property database, an electromagnetic property database, a standard metal database, a mechanical property database, a thermal treatment property database and an accessory database.

17. The hardness measurement method according to claim 11, further comprising:
displaying a classification result by a display device, and the classification result comprises the hardness classification model and the hardness of the metal object.

18. The hardness measurement method according to claim 11, wherein the electromagnetic sensing device comprises:
a signal generator, coupled to the processing device, and configured to receive the control signal, and the signal processor generates a driving signal and a reference signal according to the control signal;
a driving circuit, coupled to the signal generator and the sensing coil, and configured to receive the driving signal, and drive the sensing coil according to the driving signal to sense the metal object, so that the sensing coil outputs a sensing signal; and
a signal processor, coupled to the signal generator and the sensing coil, and configured to receive the reference signal and the sensing signal, and the signal processor compares the reference signal and the sensing signal to output the electromagnetic sensing result to the processing device.

19. The hardness measurement method according to claim 18, wherein the sensing coil generates an alternating magnetic field, so that the metal object correspondingly generates an eddy current, and the sensing coil senses the eddy current to output the sensing signal.

20. The hardness measurement method according to claim 18, wherein the sensing coil is an annular coil, and when the metal object passes through an area encircled by the sensing coil, the sensing coil generates the sensing signal.
